(19) United States
(12) Patent Application Publication
(10) Pub. No.: US 2013/0009844 A1
(43) Pub. Date: Jan. 10, 2013

(54) AERIAL COMPRISING A MATCHING DEVICE

(76) Inventors: Dmitry Vitalevich Fedosov, Omsk (RU); Vitaly Lvovich Khazan, Omsk (RU); Vladislav Nikolaevich Khorvat, Omsk (RU)

(21) Appl. No.: 13/511,421

(22) PCT Filed: Nov. 17, 2010
(86) PCT No.: PCT/RU10/00676

§ 371 Date: Jun. 23, 2012

(30) Foreign Application Priority Data
Dec. 4, 2009 (RU) 2009145078

(51) Int. Cl. H01Q 1/50

(52) U.S. Cl. 343/860

(57) ABSTRACT

The invention relates to antenna technical equipment and can be used as the small-sized aerial. The technical result is significant reduction of overall dimensions of the aerial while retaining sufficient efficiency of radiation within the LW, MW and SW radio communication range and as a result the expansion of the functional abilities of the use of transceiving equipment. Aerial comprising a matching device including inductances contains radiating element. The radiating element is located in a magnetic field of the matching device implemented in the form of the transformer. The transformer is located on open magnetic circuit. The radiating element is electrically connected to the secondary winding of the transformer.

This invention relates to antenna equipment and can be used in a small-sized transceiving radio communication and navigation units, as well as a separate aerial to be mounted on both stationary and mobile communication facilities.

The design of the small-sized ferrite aerial with a ferromagnetic core and receiving coils placed on it (the Patent of the Russian Federation No.2344433) is known.

The drawback of the above aerial is that it can be used only as a receiving antenna, since in the mode of a radio signal delivery to the ferrite aerial, ferromagnetic material being saturated results in distortions of transmitted signal.

A broadband image oscillating antenna as per the Patent of the Russian Federation No. 234267 MPK HO1Q 9/18, containing a vertical oscillator (radiating element) connected to the inner conductor of a coaxial cable, a matching device comprising both the first and the second inductance, antenna inductance coil, the first and the second resistors, as well as an oscillator (radiating element) with a circular polar pattern in horizontal plane is known.

The above mentioned image oscillating antenna has the drawback: the height of the vertical rectangular radiating element makes 0.038λ where λ is the highest wavelength of operating band that makes 7,6 m at frequency of 1.5 MHz. Taking into account the flat rectangular design of the antenna, one can arrive at a conclusion that the application of the above design in LW and MW bands in a mobile version is hardly technically feasible and in most cases is quite impossible.

The dimensions of modern low-frequency radio communication aerials are known to make dozens and hundreds meters which substantially inhibits their application in mobile radio communication and prolongs the installation period of stationary aerials for radio communication. These types of aerials impede the development and application of radio communication itself, as well as progress in the design of long-wave and medium wave bands transceiver devices. Due to some specific features of long-waves and medium waves propagation in the space these bands appear to be the most attractive and applicable for distant radio communication.

The technical result of the claimed invention relates to the decrease of overall dimensions of the aerial while retaining sufficient efficiency of radiation so as to expand the functionalities of the use of radio equipment in mobile systems of LW, MW and SW radio communication.

The specified technical result is achieved so that in the aerial comprising a matching device in the form of the transformer with open magnetic circuit and a radiating element connected to the secondary winding of the transformer according to the claimed invention radiating element is located in a magnetic field of matching transformer.

The invention can be industrially realized by means of facilities, technologies and materials already available and, hence, it fully meets the <<industrial applicability>> criterion requirements.

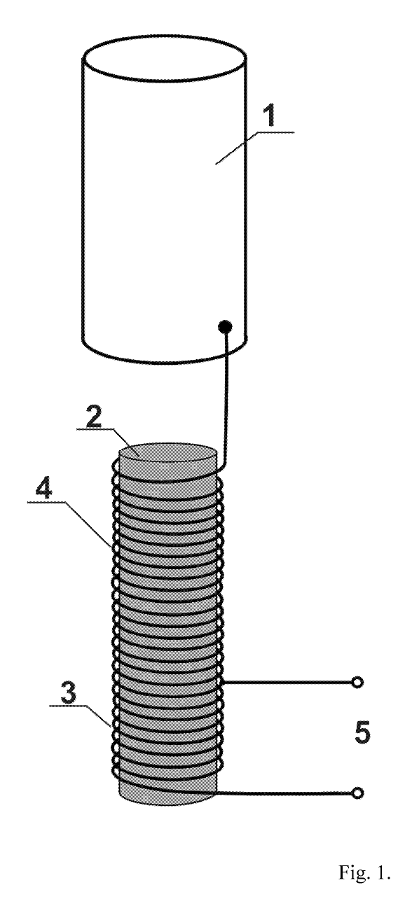

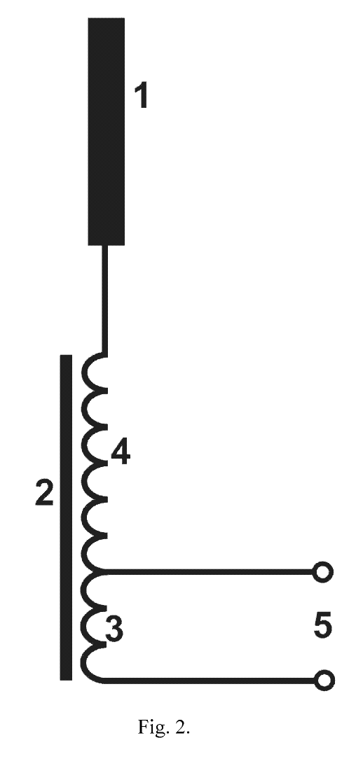

The invention is illustrated in the accompanying drawings, where FIG. 1 depicts the structural layout of the presented aerial, while in FIG. 2 its equivalent electric circuit layout is presented.

Aerial comprising a matching device consists of radiating element and the transformer. The radiating element 1 of any form or shape, for example, in FIG. 1 it is a cylinder, can be made of any conductive material. The transformer is implemented on the open magnetic circuit 2 and contains the inductance coils in the form of primary 3 and secondary 4 windings of this transformer. The radiating element 1 is electrically connected to a secondary winding 4 of transformer and should be in a magnetic field of the transformer. A feed of the aerial is carried out through a primary winding 3 of the transformer by means of a cable or directly from an antenna socket of the radio transmitting device via any connecting unit 5.

The aerial comprising a matching device works as follows.

When a signal from the connecting unit 5 is fed to the primary winding 3 of the transformer a magnetic field is induced in the open magnetic circuit 2 and around it, the magnetic induction vector of that field is directed along the magnetic circuit. The electric field the E-vector of which is directed perpendicularly to the plane of the radiating element 1 emerges due a high voltage feed from the secondary step-up winding 4 of the transformer electrically connected to the radiating element 1. On the assumption that the radiating element 1 is inside the operating zone of the magnetic field of the transformer in such a way that the angle between the magnetic induction vector and E-vector of the electric field induced on the radiating element 1 is close to 90° then sufficient conditions for radio waves generation arise in the vicinity of the radiating element.

This invention provides significant reduction of overall dimensions of the aerials applied in LW, MW and SW communication and, as consequence, a high maneuverability and mobility of the equipment and communication systems, reduction of manufacture expenses, increase of a mobile radio communication range, transmission security if necessary and convenience of the aerial mounting; an efficient utilization of space occupied by the aerial and as a result of all aforesaid technical development and attraction of investments to this sphere of communication.

1. Aerial comprising a matching device in the form of the transformer with open magnetic circuit and a radiating element connected to the secondary winding of the transformer has a distinctive feature that the radiating element is located in a magnetic field of a matching transformer.
